(19) United States
(12) Patent Application Publication
(10) Pub. No.: US 2007/0206443 A1
(43) Pub. Date: Sep. 6, 2007

(54) Method and system for providing user interface of calendar planner application in mobile phone

(75) Inventors: Jae Joon Hwang, Seoul (KR); Tae Kyung Kim, Yangju-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/712,213

(22) Filed: Feb. 28, 2007

(30) Foreign Application Priority Data
Feb. 28, 2006 (KR) 2006-0019577

(51) Int. Cl. G04C 17/00; G04B 19/24

(52) U.S. Cl. 368/29

(57) ABSTRACT

A method and system for providing a user interface for a calendar planner application in a mobile phone. The method includes determining whether a string of digits is input, displaying the string of digits if at least one digit is input, counting the number of digits in the string, and displaying a month view in which a day indicated by the string of the digits is highlighted, the day being defined according to the number of the digits. The method and system for providing a user interface for a mobile phone according to the present invention allows a user to quickly navigate the calendar so as to reach an intended day or month by direct number key inputs, thus enhancing ease of use.

### PRIORITY

This U.S. non-provisional application claims priority under 35 U.S.C. §119 to an application entitled “METHOD AND SYSTEM FOR PROVIDING USER INTERFACE OF CALENDAR PLANNER APPLICATION IN MOBILE PHONE” filed in the Korean Intellectual Property Office on Feb. 28, 2006 and assigned Serial No. 2006-0019577, the contents of which are incorporated herein by reference.

### BACKGROUND OF THE INVENTION

1. Field of the Invention

The present invention relates to a mobile phone and, in particular, to a method and system for providing a user interface of a calendar planner application of a mobile phone.

2. Description of the Related Art

As mobile phones have gained widespread acceptance as an efficient means of voice and data communications, the market for mobile wireless devices has increased dramatically. The success of mobile communication lies in the abilities to provide instant connectivity almost anytime and anywhere, and to provide various services such as wireless Internet access, Short Message Service (SMS), on-demand multimedia services, etc.

Recently, mobile phones have been implemented with additional functions so as to be used for as personal schedulers, data communication devices, and/or for basic voice communication devices. In addition, mobile phones integrated with various digital devices such as image processors, virtual 3-dimensional stereo sound modules, MP3 modules, camera modules, etc. have emerged onto the market.

Sometimes, these mobile phones are called Internet phones, data communication phones, multimedia phones, health assistant phones, game phones, and the like, according to their additional functions. Further, many newer mobile phones can receive digital television broadcasting signals and support a video-on-demand (VOD) service.

As the mobile phones are typically equipped with various digital devices and implemented with various functions, designing user interfaces for mobile phones presents unique challenges in view of the limited miniaturized size, the limited number of controls that can be accommodated on such devices, and the need for quick, simple, and intuitive device operation. In order to enable effective operation of the various application functions of the mobile phones and to simplify the manipulation of the mobile phones, various user interfaces have been proposed.

Typically, mobile phones provide calendar planners in order to manage the user's appointments and plans, in which the user may enter text into the calendar planner through keypad manipulation.

However, conventional keypad-based calendar planner controls typically require several navigation key manipulations in order to move to a target day in the calendar, which can be inconvenient. Also, the repetitive navigation key manipulations cause delays in reaching the target day.

### SUMMARY OF THE INVENTION

The present invention has been made in an effort to solve the above problems, and it is an object of the present invention to provide a method and device for providing a novel user interface for a mobile phone which is capable of improving the user's manipulation convenience.

It is another object of the present invention to provide a method and device for providing a user interface for a mobile phone which is capable of facilitating the management of the appointments and plans with a calendar planner application.

In one aspect of the present invention, the above and other objects can be accomplished by a method for providing a user interface of a calendar planner application for a portable device. The method includes determining whether a string of digits is input, displaying the string of digits if at least one digit is input, counting a number of digits of the string, and displaying a month view in which a day indicated by the string of the digits is highlighted, the day being defined according to the number of the digits.

In another aspect of the present invention, the above and other objects can be accomplished by a method for providing a user interface of a calendar application for a portable device. The method includes displaying a month view of a month having a current day when an execution command is input for operating the calendar planner application, determining whether a string of digits is input, displaying the string of the digits, if the string of digits is input, and displaying a month view of a month having a day corresponding to the string of the digits after the input of the digits is completed, the day being highlighted.

In another aspect of the present invention, the above and other objects can be accomplished by a method for providing a user interface of a portable device. The method includes detecting key signals input through keys, displaying digit values corresponding to the keys if the key signals are input, retrieving a program corresponding to the digit values, and operating the retrieved program.

In another aspect of the present invention, the above and other objects can be accomplished by a method for providing a user interface. The method includes displaying an initial calendar screen if a calendar planner application is requested, detecting signals generated by key inputs while the initial calendar screen is displayed, extracting digit values from the signals, and displaying a screen on the basis of the digit values.

In another aspect of the present invention, the above and other objects can be accomplished by a system for providing a user interface of a calendar planner application for a mobile phone. The system includes a sensor which detects a string of digits corresponding to number keys, a display which displays the string of the digits, and a controller which counts a number of the digits of the string and operates a function corresponding to the number of the digits.

In another aspect of the present invention, the above and other objects can be accomplished by the system for providing a user interface of a calendar planner application for a portable device. The system includes a display which displays an initial calendar screen if the calendar planner application is requested, a sensor which detects signals generated by key inputs while the initial calendar screen is displayed, an analyzer which analyzes the key input signals to extract digit values corresponding to from the key input signals, and a controller which controls display of the extracted digits valves on the display.

### BRIEF DESCRIPTION OF THE DRAWINGS

The above and other objects, features and advantages of the present invention will be more apparent from the following detailed description taken in conjunction with the accompanying drawings, in which:

FIG. 1 is a screen illustrating a planner calendar application provided by a mobile phone according to the present invention;

FIG. 2A to FIG. 2D are screen shots illustrating operational steps of a user interface according to the present invention;

FIG. 3 is a block diagram illustrating a mobile phone according to the present invention;

FIG. 4 is a flowchart illustrating a method for providing a user interface of a calendar planner application for a mobile phone according to the present invention;

FIG. 5 is a flowchart illustrating the key input procedure of the method of FIG. 4; and

FIG. 6 is a flowchart illustrating the input signal checking process of the method of FIG. 4.

### DETAILED DESCRIPTION OF THE PREFERRED EMBODIMENTS

A preferred embodiment of the present invention will be described in detail herein below with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present invention.

The present invention provides a user interface which allows a user to manipulate a calendar planner provided by a portable device. In the present invention, navigation of the calendar is carried out number keys provided with the portable device. According to the present invention, the number-keys-based navigation can be adapted to other applications of the portable device. For example, the user can search and load an application using predetermined number keys.

The user interface of the present invention allows the user to input a day directly using the number keys while the calendar is displayed on the screen, and opens the day view screen of the day.

Even though the user interface of the present invention is described with regard to a mobile phone, the present invention is not limited to the mobile phone, but, is intended to cover various portable devices such as Personal Digital Assistants (PDAs), smart phones, MP3 players, laptop computers, personal computers, audio devices, televisions, digital cameras, and the like.

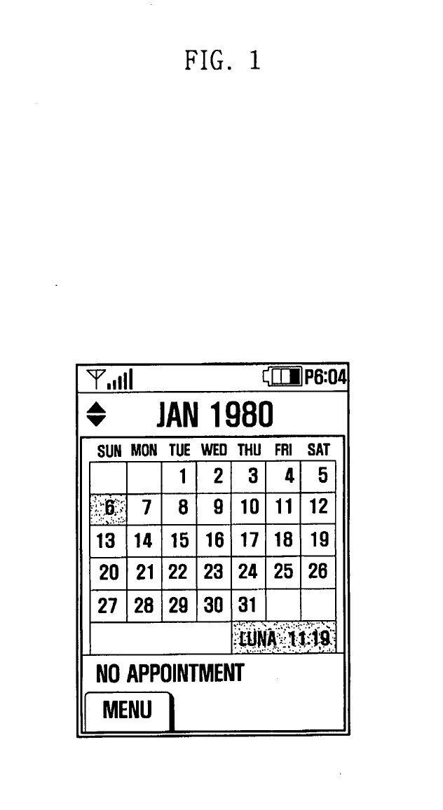

FIG. 1 is a screen illustrating a planner calendar application provided by a mobile phone according to the present invention.

Referring to FIG. 1, shown is a month view of the planner calendar which is divided into a grid, where the columns are the days of the week and the rows are the weeks. Preferably, the current day is activated with an highlighted color. The month view also allows the user to days of the month on which the user has appointments or plans.

When the user desires to move the cursor from the current day to another day, the user inputs directly the numbers corresponding to the day, month, and year of the target day using the number keys provided by the mobile phone.

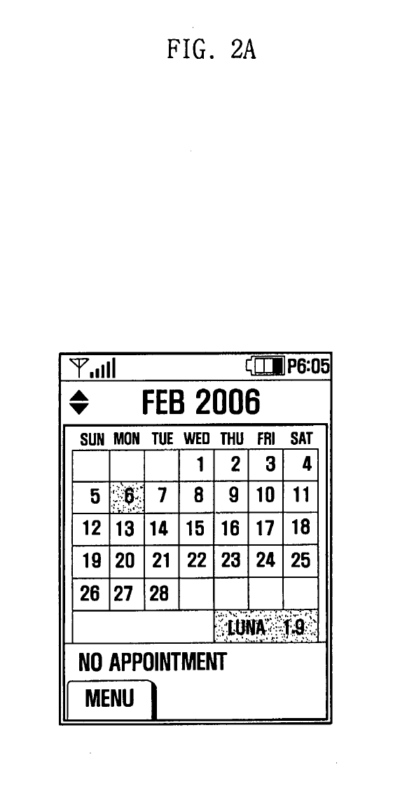

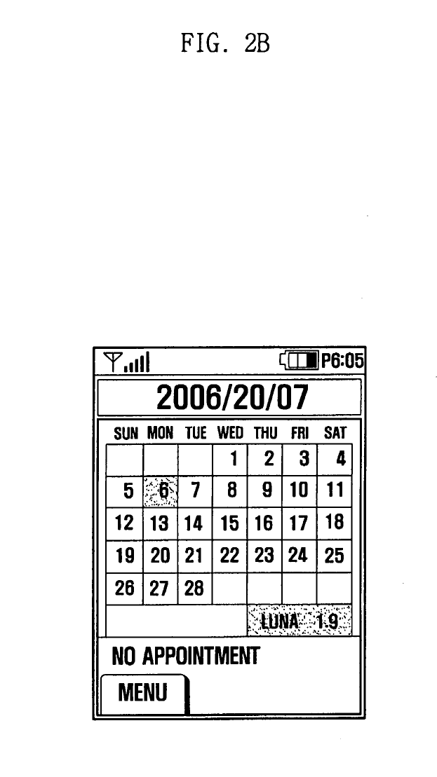

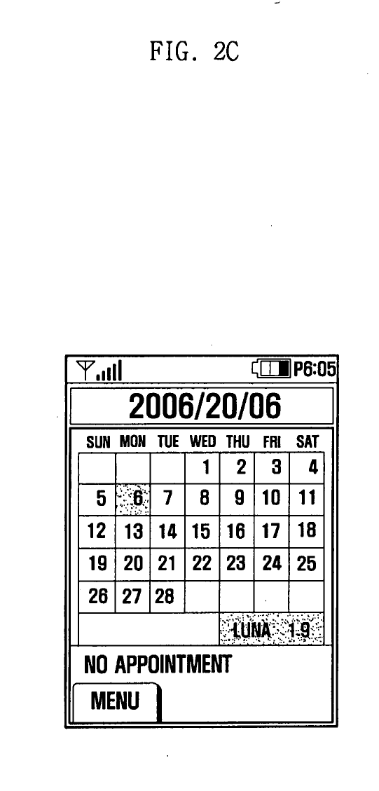

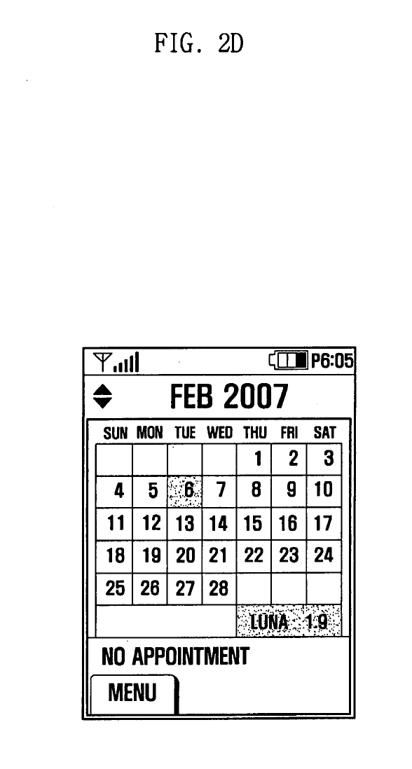

The operation of the user interface according to the present invention is described with reference to FIG. 2A to FIG. 2D.

FIG. 2A to FIG. 2D are screen shots illustrating operational steps of a user interface according to the present invention.

When a planner calendar application is requested to be loaded, the mobile phone displays the planner calendar in the month view with a manufacture's default setting or a user's custom setting. In FIG. 2A, as an example February of the year 2006 is displayed in the month view screen and the sixth day is activated as the current day.

While the month view is displayed, the user can check the days having appointments and plans by opening a target day by directly inputting the numbers corresponding to the target day, so as to watch detailed appointments and plans of the target day.

For example, if the user wants to see the appointments and plans of Feb. 6, 2007 while the cursor is on Feb. 6, 2006, the user inputs the number 20070206 representing the target day.

If a number key input is performed while the month view screen of FIG. 2A is displayed, the mobile phone shows the digits next as the number input through the keypad.

For example, if the four digits 2007 representing the year of the target day are entered when “2006/02/07” is currently displayed at the top of the month view screen, the mobile phone deletes digits 0207 from the end and displays 2007 following 2006 representing the year of the current day at the top of the month view screen in the form of 2006/20/07 as shown in FIG. 2B. In more detail, when a number key of 2 is input for entering the year 2007 of the target day, the mobile phone activates a text box such that the user can enter the remaining digits, as seeing the input digits in the text box.

If the year digits 2007 are completely input, the string of digits representing the current day, which is displayed in the form of 2006/02/06, is replaced by the string of digits representing the target day 2006/20/07 in the text box. That is, the 4 digits of 02/06 representing the current month and day are replaced by the newly input string of digits 2007 in the form of 20/07.

Referring to FIG. 2C, if the number 0206 representing the target month and day are input after the 4 digits 2007 are entered, the string of digits 2006 representing the year of the current day is next shifted left to disappear. Accordingly, the text box is filled out by the target day in the form of 2007/02/06.

That is, the user can enter the 8 digits 20070206 representing the target day Feb. 6, 2007, checking the entered digits through the text box while entering the digits, and the entered digits are displayed in the form of 2007/02/06 after the string of the digits representing the target day is completely entered.

As such, the text box is displayed at the top of the month view screen, however, the means of showing the entered number is not limited to the text box but can be implemented with a floating window or a popup window.

After all the digits representing the target day are input, the mobile phone displays the calendar of the month of the target day as a month view, in which the target day is highlighted, as shown in FIG. 2D.

As described above, the user interface according to the present invention allows the user to move to the target day by directly inputting the string of digits representing the target day.

If an enter key is pushed while the month view screen is displayed as in the FIG. 2A, the day view screen (not shown) is opened so as to show the appointments and plans made for the highlighted day.

Accordingly, the movement between days is carried out by inputting 8 digits representing a day, however the present invention is not limited to the 8-digit input, but is intended to cover various modifications. For example, in order to move to the target day in the same month of the same year, only one or two digits may be required to be input. Accordingly, it is required to input one or two digits ‘9’ or ‘09’ for moving to the ninth day of the same month, and two digits ‘17’ for the seventeenth day.

In case of the movement to a target day of another month of the same year, it can be performed by inputting 3 or 4 digits representing the month/day in the sequential order of month and day. For example, if the target day is March 15 of the same year, it is required to input the string of 3 or 4 digits ‘315’ or ‘0315.’ Of course, the movement to the target day can be performed by inputting the day in 4- or 8-digit manner as well as in 2-digit manner, i.e., ‘15,’ ‘0315,’ or ‘20070315.’

As described above, the user interface of the present invention allows the user to move to a target day by inputting 2, 4, or 8 digits according to the movement scale, such that the user can quickly check the appointments and plans of the target day.

The mobile phone implemented with a user interface according to the present is described hereinafter in detail.

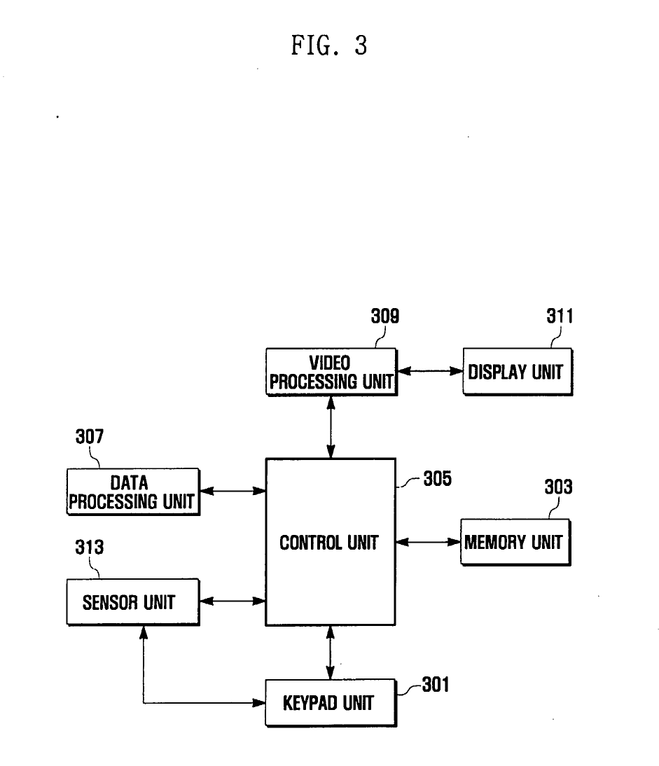

FIG. 3 is a block diagram illustrating a the mobile phone according to the present invention.

Referring to FIG. 3, the mobile phone includes a keypad unit 301, a memory 303, a control unit 305, a data processing unit 307, a video processing unit 309, a display unit 311, and a sensor unit 313.

The keypad unit 301 is provided with a plurality of keys for inputting the numbers and characters and operating various functions. Particularly, the keypad unit 301 is implemented with predetermined function keys which allow the user to operate the calendar planner application.

The memory unit 303 includes a program memory and a data memory. The program memory stores the programs for operating the general functions of the mobile phone and the application programs for operating the user interface, especially the calendar planner user interface.

The data memory stores, temporarily, the data generated while the application programs operate, especially the data related to the calendar planner application such as appointments, plans, and alarm settings.

The control unit 305 controls the overall operation of the mobile phone and especially the operations related to the calendar planner application. The control unit 305 controls such that the calendar planner application operates according to signal input through the keypad unit 301. The sensor unit 313 detects the signals input through the keypad unit 301 and transmits the detected signal to the control unit 305.

If the key input signal is received from the sensor unit 313, the control unit 305 analyzes the key input signal and performs an operation corresponding to the analyzed key value. The operation status is displayed on the display unit 311.

For example, if a string of 4 digits is input while the calendar planner application operates, the control unit 305 analyzes the 4-digit signal and obtains a month value and a day value from the 4-digit signal representing the target day.

In case that a string of 8 digits are input, the control unit 305 extracts a year value, a month value, and a day value from the 8-digit signal. Preferably, the 8-digit string includes 4 year digits, 2 month digits, and 2 day digits and is displayed in the form of xxxx/xx/xx (representing year/month/day).

While the target day planner is open in the day view screen, the control unit 305 controls the calendar planner application such that the user can select each appointment or plan arranged and edit the contents of the selected appointment or plan.

The data processing unit 307 is responsible for processing the data related to the calendar planner application to output the user's appointments and plans with additional information or alarms in the predetermined format.

The video processing unit 309 processes video signals to be appropriate for the display unit 311 under the control of the control unit 305. The video processing unit 309 also processes the information related to the calendar planner application such as current time and date and the event signal detected through the sensor unit 313 such that the information is displayed on the display unit 311.

The display unit 311 displays the video data output from the video processing unit 309 together with the current time, appointments, and plans in the form of day view, week view, or month view according to the user instructions input through the keypad unit 301.

The sensor unit 313 is activated when the predetermined application program, i.e., the calendar planner application, operates such that the sensor unit 313 detects the application related key event. The sensor unit 313 can be implemented with a key event analyzer (not shown) for analyzing the key event to obtain the corresponding key value. Of course, the key event analyzer can be integrated with the sensor unit 313 or separately installed in the mobile phone.

When the key event analyzer is adopted, it analyzes the key signal detected by the sensor unit 313 and estimates the key value corresponding to the key input signal. If it determines that the key input signal is generated by a number key, the key event analyzer transmits a corresponding key value to the control unit 305. If the key input signal is not generated by a number key, the key event analyzer generates a control signal corresponding to the key event and transmits the control signal to the control unit 305.

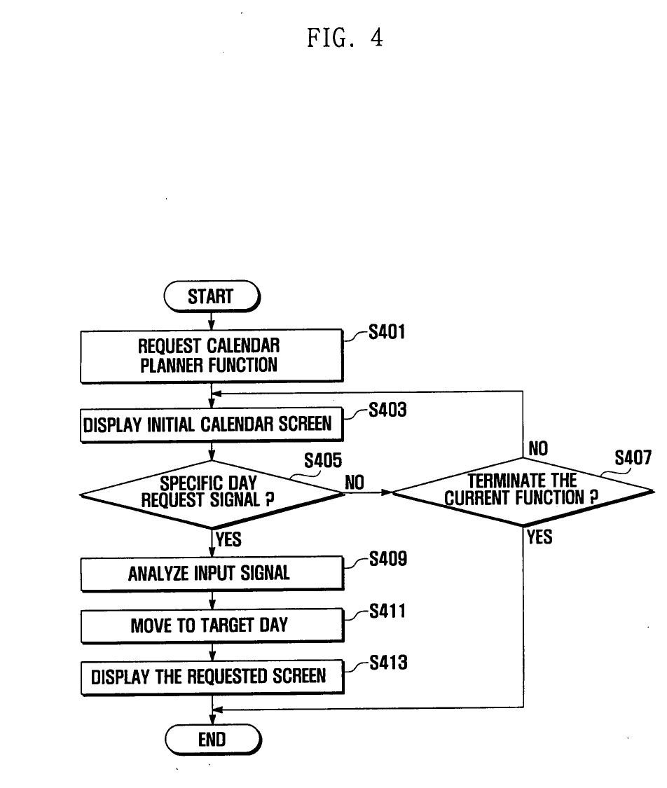

FIG. 4 is a flowchart illustrating a method for providing a user interface of a calendar planner application for a mobile phone according to the present invention.

Referring to FIG. 4, when a calendar planner application is requested by the user at step S401, the mobile phone displays an initial calendar planner screen (see FIG. 2A) at step S403. Preferably, the initial calendar planner screen provides current time data.

While the initial calendar planner screen is displayed, the mobile phone determines whether a specific day request signal is input through the keypad at step S405. If it is determined that specific day request signal is not input in a predetermined time, the mobile phone alerts so as to allow the user to decide whether to terminate the calendar planner application at step S407. If the mobile phone determines that the user decided to terminate the calendar planner application with a specific key input at step S407, the mobile phone disables the calendar planner application. The specific key could be a cancel key, an end key or a hot key.

Whereas, if the mobile phone determines that the user decided not to terminate the calendar planner application at step S407, the mobile phone performs the step S403.

For example, if a number key is not input within a predetermined time, the mobile phone repeats the step S403 and continues to wait for a key input.

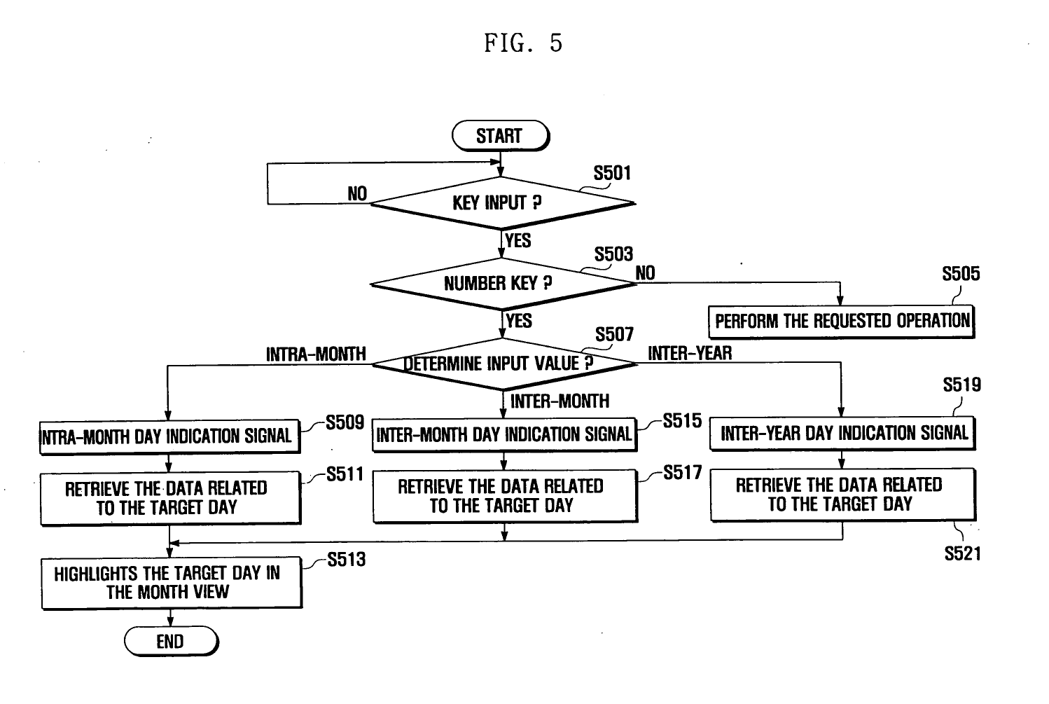

If the specific day request signal is input at step S405, the mobile phone analyzes the key input so as to estimate a value corresponding to the key input at step S409. The specific day request signal is generated in the form of a string of digits generated by inputting sequential number keys. At this time, the mobile phone waits for a predetermined time after a number key is input to determine where the specific day request signal is completed. That is, if there is no further key input within the predetermined time, the mobile phone determines the specific day request signal is completely input. The key input analysis is performed upon the completion of the key input. The key input analysis procedure is described in more detail with reference to FIG. 5.

After completion of the key input analysis, the mobile phone retrieves the target day and its related data at step S411 and displays, in a month view screen, a calendar of the month to which the target day belongs at step S413. If there is any appointment or plan made at the target day, it can be indicated with an icon or partially displayed.

FIG. 5 is a flowchart illustrating the key input procedure of the method of FIG. 4.

Referring to FIG. 5, the mobile phone monitors the keypad to determine whether a signal is input through the keypad at step S501. If a signal is input through the keypad, the mobile phone determines whether the signal is generated by a number key at step S503.

If it is determined that the signal is not generated by a number key, the mobile phone performs an operation corresponding to the input signal at step S505.

If the signal is generated by input of number keys, the mobile phone determines whether the input signal is an intra-month day indication signal, an inter-month day indication signal, or an inter-year day indication signal at step S507. The intra-month day indication signal represents the target day with only the 2-digit day, the inter-month day indication signal represents the target day with next arranged 2-digit month and 2-digit day, and the inter-year day indication signal represents the target day with next arranged 4-digit year, 2-digit month, and 2-digit day.

If it is determined that the input signal is the intra-month day indication signal, the mobile phone checks the target day indicated by the intra-month day indication signal at step S509 and retrieves the data related to the target day at step S511. Next, the mobile phone highlights the target day in the month view together with an icon indicating that at least one appointment or plan is made, at step S513.

In the meantime, if it is determined that the input signal is the inter-month day indication signal at step S507, the mobile phone checks the month and day values of the target day indicated by the inter-month day indication signal at step S515 and retrieves the data related to the target day of the target month at step S517. Next, the mobile phone highlights the target day in the month view together with the icon which indicates that at least one appointment or plan is made, at step S513.

Otherwise, the mobile phone determines that the input signal is the inter-year day indication signal at step S519 and retrieves the data related to the target day of the target month of the target year at step S521. Next, the mobile phone highlights the target day in the month view together with the icon indicating that at least one appointment or plan is made, at step S513.

Here, an intra-month day indication signal, an inter-month day indication signal, or an inter-year day indication signal are determined according to the number of the digits constituting the input signal.

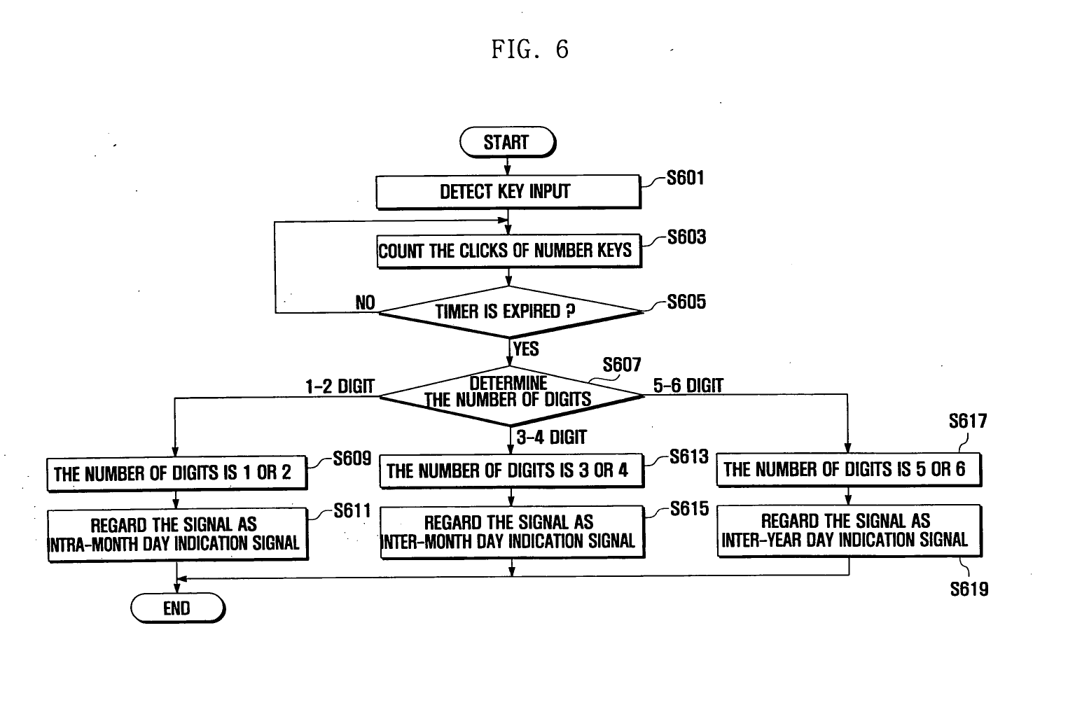

FIG. 6 is a flowchart illustrating the input signal checking process the method of FIG. 4.

Referring to FIG. 6, the mobile phone detects a series of key input at step S601 and counts the number of the clicks on the number keys at step S603. Next, the mobile phone determines whether the key input is completed at step S605. That is, the mobile phone activates a timer whenever a number key is clicked and determines that the key input is complete when there is no key input before the timer expires.

If it is determined that the key input is complete, the mobile phone determines the number of digits input by the number keys at step S607. If it is determined that the number of digits is 1 or 2 at step S609, the mobile phone regards the input signal as an intra-month day indication signal at step S611. If it is determined that the number of digits is 3 or 4 at step S613, the mobile phone regards the input signal as an inter-month day indication signal at step S615. If it is determined that the number of the digits is 6 or more at step S617, the mobile phone regards the input signal as an inter-year day indication signal at step S619.

As described above, the method and system for providing a user interface of a portable device according to the present invention allows a user to directly input the digits of a day for checking appointments and plans of the day while using a calendar planner application, so that it is possible to reduce operation delay caused by navigation key manipulations.

The method and system for providing a user interface of portable device according to the present invention also allows the user to quickly navigate the calendar so as to reach an intended day or month by direct number key inputs, resulting in manipulation convenience.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A method for providing a user interface of a calendar planner application for a portable device, comprising:
determining whether a string of digits is input;
displaying the string of digits if at least one digit is input;
counting a number of digits in the string; and
displaying a month view in which a day indicated by the string of the digits is highlighted, the day being defined according to the number of the digits in the string.

2. The method of claim 1 further comprising:
determining whether a command signal is input; and
performing an operation corresponding to the command signal.

3. The method of claim 1 further comprising:
determining whether an execution command is input while the month view having the highlighted day is displayed; and
displaying appointments and plans corresponding to the highlighted day.

4. A method for providing a user interface of a calendar planner application for a portable device, comprising:
displaying, when an execution command is input for operating the calendar planner application, a month view of a month having a current day;
determining whether a string of digits is input;
displaying, when a string of digits is input, the string of the digits; and
displaying a month view of a month having a highlighted day corresponding to the string of digits after the input of the digits is completed.

5. The method of claim 4, further comprising:
determining whether a command signal is input; and
performing an operation corresponding to the command signal.

6. The method of claim 4, further comprising:
determining whether an execution command is input while the day is highlighted in the month view; and
displaying appointments and plans corresponding to the highlighted day.

7. The method of claim 4, further comprising counting the number of digits in the string of digits.

8. The method of claim 4, wherein the step of displaying the month view comprises:
checking values of the digits;
retrieving the day and data corresponding to the values; and
displaying the highlighted day and the data in the month view.

9. A method for providing a user interface of a portable device, comprising:
detecting key signals input through keys;
displaying, when key signals are input, digit values corresponding to the keys;
retrieving a program corresponding to the digit values; and
operating the retrieved program.

10. The method of claim 9, wherein the step of retrieving the program comprises:
counting a number of the digit values; and
retrieving the program in accordance with the number of the digit values.

11. A method for providing a user interface of a calendar planner application for a portable device, comprising:
displaying an initial calendar screen if the calendar planner application is requested;
detecting signals generated by key inputs while the initial calendar screen is displayed;
extracting digit values from the signals; and
displaying a screen in accordance with the digit values.

12. The method of claim 11, wherein the extracting step comprises:
determining the digit values of the key inputs;
navigating, if the digit values represent an intra-month day indication signal, the displayed month for retrieving a target day;
navigating, if the digit values represent an inter-month day indication signal, a different month of the displayed year for retrieving the target day;
navigating, if the digit values represent an inter-year day indication signal, a month of a different year for retrieving the target day; and
highlighting the target day in a month view of a month corresponding to the target day.

13. The method of claim 12, wherein the type of the day indication signal is determined based on the number of the digits.

14. The method of claim 12, wherein the intra-month day indication signal comprises 1-2 digit signal, the inter-month day indication signal comprises a 3-4 digit signal, and the inter-year day indication signal comprises a 5-6 digit signal.

15. The method of claim 12, further comprising determining whether the key inputs are completed.

16. The method of claim 15, further comprising determining that the key inputs are completed upon detecting that a key input has not occurred within a predetermined time period after a predetermined key is pushed.

17. The method of claim 15, further comprising determining that the key inputs are completed upon detecting that a key input has not occurred within a predetermined time period after a previous key input.

18. The method of claim 15, further comprising determining that the key inputs are completed upon detecting an enter key has been input.

19. A system for providing a user interface of a calendar planner application for a portable device, comprising:
a sensor for detecting a string of digits corresponding to number keys;
a display for displaying the string of digits; and
a controller for counting the number of digits in the string and operating a function corresponding to a number of digits in the string.

20. The system of claim 19, wherein the controller monitors a signal input by a key other than a numerical key and performs an operation associated with the key which is other than a numerical key.

21. The system of claim 19, wherein the controller determines whether a key instruction is input using a predetermined key and displays detailed contents associated with a day according to the key instruction.

22. The system of claim 19, wherein the controller displays a month view of a month including a current day, the month view notifying existence of appointments and plans corresponding to each day, and switches to another month view having a target day defined by the string of digits when key inputs are completed.

23. The system of claim 19, wherein the controller determines the number of the digits input.

24. A system for providing a user interface of a calendar planner application for a portable device, comprising:
a display for displaying an initial calendar screen if the calendar planner application is requested;
a sensor for detecting key input signals generated by key inputs while the initial calendar screen is displayed;
an analyzer for analyzing the key input signals so as to extract digit values from the key input signals; and
a controller for controlling display of the extracted digit values on the display.

25. The system of claim 24, wherein the controller determines the digit values corresponding to the key inputs, navigates a displayed month for retrieving a target day if the digit values correspond with an intra-month day indication signal, navigates a different month of the displayed year for retrieving the target day if the digit values correspond with an inter-month day indication signal, navigates a different month of a different year for retrieving the target day if the digit values represent an inter-year day indication signal, and highlights the target day in a month view of a month corresponding to the target day.

26. The system of claim 24, wherein the analyzer determines whether the signals are digit signals, counts the number of the digits when the signals are determined to be digit signals, and performs an operation corresponding to the key input signals when the key input signals are determine to be other than digit signals.

27. The system of claim 24, wherein the controller controls the display so as to display a month view according to the digit values which represent at least one of an intra-month day indication signal, an inter-month day indication signal, and an inter-year day indication signal.
